(19) United States
(12) Patent Application Publication
(10) Pub. No.: US 2017/0032719 A1
(43) Pub. Date: Feb. 2, 2017

(54) BALLOON AND METHODS OF ATTACHING A BALLOON TO A SUPPORT STRUCTURE

(71) Applicant: BETALLIC, L.L.C., St. Louis, MO (US)

(72) Inventor: Maureen Day, St. Charles, MO (US)

(21) Appl. No.: 15/000,371

(22) Filed: Jan. 19, 2016

Related U.S. Application Data
(63) Continuation-in-part of application No. 14/810,661, filed on Jul. 28, 2015.

(51) Int. Cl. G09F 23/00; F16B 47/00; A47G 29/12

(52) U.S. Cl. CPC G09F 23/00; A47G 29/12; F16B 47/003

(57) ABSTRACT

A decorative balloon is designed specifically to directly attach to an outer surface of the mailbox. The balloon may be an air-filled foil balloon and may include an inner pocket surface that hugs and snugly adheres to an outer surface of the mailbox.

### CROSS REFERENCE TO RELATED APPLICATIONS

This application is a continuation-in-part application of U.S. application Ser. No. 14/810,661 filed Jul. 28, 2015, the complete disclosure of which is hereby incorporated by reference in its entirety.

### BACKGROUND OF THE INVENTION

The field of the invention relates generally to decorative inflatable balloons and methods of mounting decorative balloons to a support element in order to display the balloon at a desired location to signify a location for an event or a celebration.

Decorative balloons are sometimes attached to mailboxes to draw attention to event celebrations like birthdays, anniversaries, births, showers, etc. Such balloons can serve general notice of an event celebration by any passerby, or specific notice to invited persons for the event celebration. For example, an invitee driving to the event may look for the balloon(s) and more easily confirm the location of the event. Conventionally, a decorative balloon inflated with helium is tethered to the mailbox with a string for such purposes. This practice is problematic in some aspects and improvements are desired.

### BRIEF DESCRIPTION OF THE INVENTION

This invention negates a need for helium and also a need for string to attach a decorative balloon to the mailbox. Accordingly, the present invention is a decorative balloon constructed in a unique shape so that when filled with air it will snugly adhere to a support element such as a mailbox.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a front elevational view of a conventional balloon attached to a mailbox in a conventional way.

FIG. 2 is a front elevational view of a first exemplary embodiment of a decorative balloon according to the present invention that is designed for direct attachment to the mailbox shown in FIG. 1.

FIG. 3 is a front elevational view of the decorative balloon shown in FIG. 2 according to the present invention attached to a mailbox.

FIG. 4 is a front elevational view of a second exemplary embodiment of a decorative balloon according to the present invention that is designed for direct attachment to the mailbox shown in FIG. 1.

FIG. 5 is a front elevational view of a third exemplary embodiment of a decorative balloon according to the present invention that is designed for direct attachment to the mailbox shown in FIG. 1.

### DETAILED DESCRIPTION OF THE INVENTION

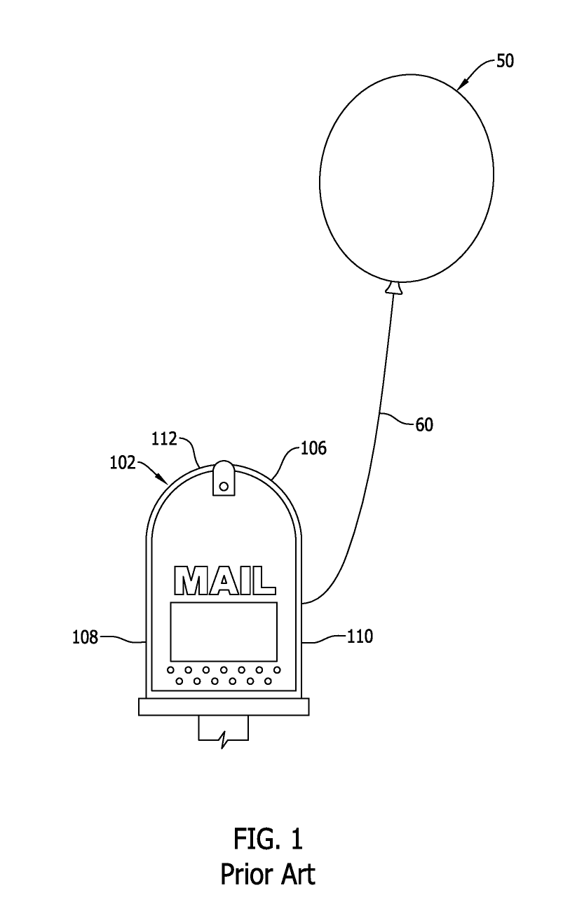

FIG. 1 illustrates a conventional use of a conventional decorative balloon 50 attached to a conventional mailbox 102 with a flexible tether 60 such as a length of string. The balloon 50 is typically filled with helium, and the tether 60 is typically provided and pre-attached to the balloon 50 at the point of purchase.

In use, the tether 60 is typically tied to the mailbox 102, and the helium filled balloon is intended to float above the mailbox 102 at a distance determined by the length of the tether 60. In this arrangement, the balloon 50 is anchored to the mailbox 102 an in indirect manner by the tether 60 and the balloon 50 is free to float and move relative to the mailbox 102.

The mailbox 102 illustrated is conventionally shaped to include opposing side surfaces 108, 110 that are substantially flat and parallel to one another, and a curved top surface 112. The tether 60 may be tied or attached to the mailbox 102 in any desired manner, and the location of the mailbox 102, typically adjacent a driveway for the location of an event or celebration, provides a convenient and conspicuous spot for guests of the event or celebration to spot the balloon 50. Additionally, neighbors or others living nearby may also see the balloon 50 and know that the event or celebration is taking place. On this note, the balloon 50 may be intended merely as a notification of a reason to celebrate, even if an event or celebration is not actually planned. For example, a homeowner may tie the balloon 50 to the mailbox to communicate to the neighborhood that a child has been born, without actually having an even or celebration for invitees.

Provided that the balloon 50 is securely tied or attached to the mailbox 102, and also provided that the weather cooperates to provide a calm environment with little or no wind, the tether 60 and balloon 50 may serve well to provide the desired notice of an event or celebration. Experience has shown, however, that securely tying the tether 60 to the mailbox 102 presents difficulties to at least some persons, and of course, the weather does not always cooperate. This arrangement of the balloon 50 being indirectly attached to the mailbox 102 with the tether 60 accordingly tends to present problems in practice.

For example, if the string tether 60 is not securely tied to the mailbox 102, the balloon 50 will detach and float away, failing to provide any of the intended notice of an event or celebration. Sometimes, the tether 60 may appear to be securely tied when it isn't, and in this scenario the balloon 50 may not immediately float away but eventually will become released from the mailbox 102 and float away if given enough time, perhaps to the surprise of the person who attempted to tie it to the mailbox.

On occasion, the balloon 50 may even float away while a person initially attempts to attach the tether 60 it to the mailbox 102. This can sometimes happen even to persons who are skilled in tying knots. While this can be rectified by obtaining another balloon that can be successfully tied, this is sometimes unpractical and in all cases inconvenient.

Another problem presented is the possibility of the string tether 60 to detach from the balloon 50. Again, and for helium filled balloons 50, such balloons will float away and disappear from sight if this happens, failing to provide any of the intended notice of an event or celebration.

Weather conditions can further complicate the reliability of each of the attachment of the string tether 60 to the balloon 50 and also the string tether 60 to the mailbox 102. Windy conditions, for example, may dislodge the string tether 60 that was at an earlier point in time successfully secured to the mailbox 102 and/or to the balloon 50. Since many events or celebrations may last for hours, and also since the balloon 50 may be placed well before the event or celebration is actually scheduled to begin, considerable changes in weather may develop between the time that the balloon 50 is first tied to the mailbox 102 and when guests actually arrive. The weather can test the attachment of the tether 60 to either the balloon 50 or to the mailbox 102 to the point of failure.

Windy conditions may also make the balloon 50 difficult to see or to read as the helium filled balloon 50 drifts back and forth or bounces above the mailbox 102. Thus, even when the balloon 50 remains attached, the weather can obscure the ability of an event guest to actually see it any given point in time.

Weather changes besides wind also may defeat the intended notice of the balloon 50. For example, rain, snow or large temperature changes may cause the balloon to float below the location of the mailbox 102 where a guest or invitee may not be expected to look for it. Such conditions may also arise even in good weather in the case of, for example, a leaky balloon 50 that over time includes less and less helium to keep it fully afloat.

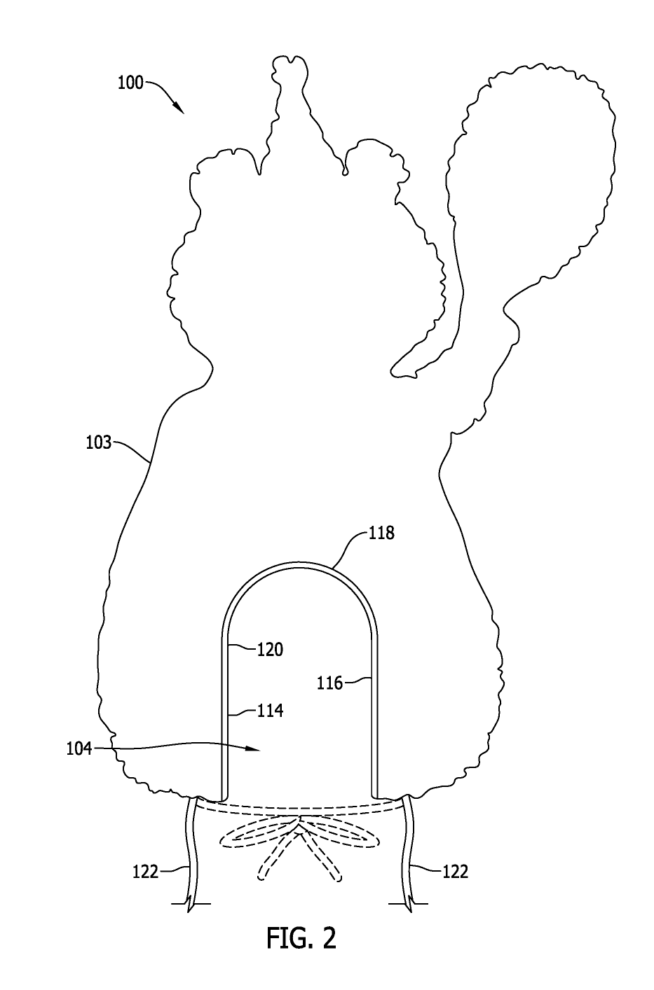

FIG. 2 shows a decorative balloon 100 that overcomes these and other difficulties. Method aspects will in part apparent and in part explicitly discussed in the following description.

The balloon 100 includes an inflatable body 103 having an exterior shape and profile chosen to match or complement a party theme, an event theme, or a celebratory theme, and an interior pocket surface 104 shaped and dimensioned to mate with and receive the mailbox 102. Direct attachment to the mailbox 102 is therefore possible, and the string tether 60 and associated difficulties of the arrangement shown in FIG. 1 may be eliminated.

The interior pocket surface 104 is seen to be complementary in shape to the outer surface 106 of the mailbox 102. That is, the interior pocket surface 104 includes opposing straight and parallel side surfaces 114, 116 that are spaced apart from one another, and a curved surface 118 connecting the upper ends of the side surfaces 114, 116. The curved surface 118 of the interior pocket in the example shown is concave, and generally matches the convex outer surface 122 of the mailbox 102.

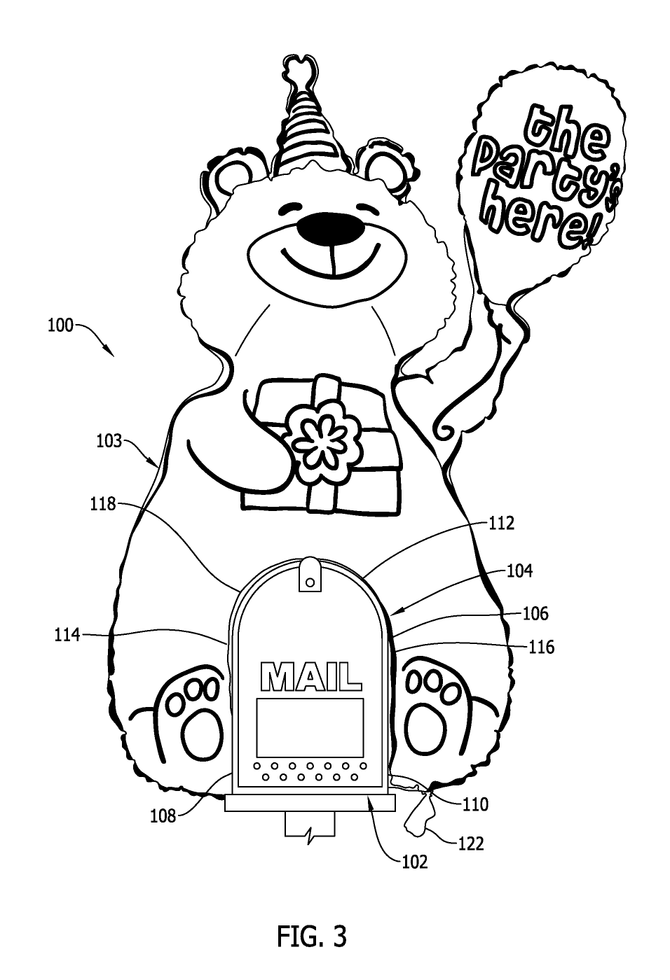

Comparing FIGS. 1 and 2, it is seen that the interior pocket surface 104 is dimensioned to receive an outer circumference of the mailbox 102 therein, such that the balloon 100 may seat upon the outer surface 106 of the mailbox 102 and the balloon 100 as shown in FIG. 3. The interior pocket surface 104 allows the balloon 100 to be directly attached to the mailbox 102 as shown in FIG. 3, as opposed to the indirect attachment with the tether 60 shown in FIG. 1. In other words, the balloon 100, via the pocket surface 104, allows the tether 60 to be eliminated in favor of direct attachment to the mailbox 102.

To achieve such positive direct attachment, the inner pocket surface 104 of the balloon 100 may be provided with an adhesive 120 on one or more of the side surfaces 114, 116 and the curved surface 118 for positive attachment of the inner surface 104 of the balloon 104 to the outer surface 106 of the mailbox 102. The adhesive may be a known pressure sensitive adhesive that may facilitate adherence to the mailbox 102 with simple pressing application by a person. Example adhesives are known and may include double sided adhesive tapes and the like. Press application, versus the more complex action of tying a knot, can be more reliably and conveniently achieved by a greater number of persons.

Advantageously, and by virtue of the direct attachment to the mailbox 102 afforded by the pocket surface 104, the inflatable body 103 of the balloon 100 may be filled with air instead of helium. The balloon 100 may be provided at lower cost, may conveniently be inflated by the purchaser at home, and may be re-used. Problems associated with the ability of the balloon to float away are avoided with an air-filled balloon, and the balloon 100 is easier to attach to the mailbox and is much more secure once installed. In some embodiments, however, the inflatable body 103 of the balloon 100 may be filled with fluids other than air, including but not limited to helium if desired.

As shown in FIG. 3 wherein the balloon 100 is attached to the mailbox 102, the balloon 102 is structurally supported by the mailbox 102 and is less impacted by wind and weather once it is in place. Steady or gusty winds will in part push the balloon against the mailbox, as will any precipitation. The complementary shapes of the mailbox 102 and the balloon pocket 104 resist any tendency of the balloon 100 to rotate relative to the mailbox 102 and become dislodged. The balloon 100 is mounted stationary relative to the mailbox 102 and would be visible at all times to arriving guests.

The balloon 100 is sometimes referred to as a Mailbox Balloon Hugger given the appearance of the pocket surface 104 to embrace and surround the outer surface 106 of the mailbox 102. The inner pocket 104 surface may rather easily be attached directly to the outer surface 106 of the mailbox 102 with simple application of pressure to engage the adhesive 120 provided in the inner pocket 104 to the outer surface 106 of the mailbox 102. Once attached, the inner pocket surface 104 hugs the mailbox 102 and snugly adheres to the outer surface 106 of the mailbox 102. Difficulties associated with an external tether 60 to indirectly attach the balloon 100 to the mailbox 102 are entirely avoided.

The balloon 100 is constructed with the body 103 that when inflated imparts the balloon 100 with a unique shape, including but not limited to the pocket 104 that is designed to fit snugly up against a standard mailbox 102. In actual practice, these specifications of the body 103 may change for each selected shape of the balloon 100, as varying seams and thickness of the air-filled portion surrounding the mailbox 102 may be desired to achieve certain shapes.

In one embodiment, the balloon body 103 may be made from Mighty Bright® brand non-foil balloon material of Betallic LLC, St. Louis, Mo. The Mighty Bright® material is a bright white material that facilitates printing of graphics on the material in bolder and brighter colors. Unlike conventional foil balloon material, the Mighty Bright® material is non-conductive and outdoor friendly.

The balloon body 103 may in one example be constructed from a laminated plastic sheet material having, for example, a first layer that is preferably fabricated of a biaxially oriented nylon, a second layer of Ethylene Vinyl Alcohol copolymer, a third layer of biaxially oriented nylon and a fourth layer of linear low density polyethylene.

The balloon body 103 in another example may alternatively be fabricated from a pair of two-dimensional flexible, generally gas-impermeable sheets such as Mylar® sheets or other suitable flexible and generally gas-impermeable polymeric material such as polyesters, polyamides, polyolefins and polyacrylates. Such polymeric sheets may or may not be decorated or “metallized” for aesthetic purposes. Alternatively, the sheets could be of latex or other elastomeric or non-elastomeric materials without departing from the scope of the present invention.

The point of inflation for the balloon 103 is positioned in the least intrusive place on the balloon body 103 so that it is not easily apparent, but instead blends into the contour of the balloon shape when inflated. Optionally, and as shown in FIG. 2, tails 122 may be provided that may be simply wrapped underneath the mailbox and tying the balloon 100 to the mailbox 102 from beneath. The tails 122 may be tied in the manner of shoelaces that persons are readily accustomed to, as opposed to knots required to attach the tether 60 (FIG. 1) that are not as familiar to as many users.

The tails 122 may be reinforced with a unique seal in the die as the balloon is manufactured to maximize the strength of the film forming the balloon body 103. The tails 102 help to keep the balloon 100 secured to the mailbox despite various weather conditions. In combination with the adhesive 120, the tails when tied to the mailbox provide a particularly sturdy mechanical connection anchoring the balloon 100 to the mailbox 102. In some embodiments, however, the balloon 120 may be provided with the tails 102 or the adhesive 120, but not necessarily both.

In use, the balloon body 100 may be inflated with helium, air or another fluid. Air is preferred as helium-filled floating balloons can render the attachment to the mailbox to be more difficult. Air is also beneficial as the balloon body 103 can be easily and conveniently inflated by the purchaser after purchase of the balloon 100 at no cost. Specialized equipment for filling the balloon with helium is not needed for the vendor or purchaser of the balloon 100. The air-filled balloon can also be advantageously deflated and re-inflated at a later time if desired, providing extra value to the consumer. Air inflation also facilitates asymmetrical shapes of the balloon that present problems for helium-filled problems such as the balloon 50 shown in FIG. 1 that are provided with a tether 60.

The construction of the balloon body 103 may vary in different embodiments depending on the inflation fluid utilized. In different embodiments, the balloon body 103 can be made from materials such as rubber, latex, polychloroprene, or a nylon fabric. The balloon body 103 can also be formed from a single-ply material such as latex balloon material, or multi-layer or ply material such as laminated foil balloons or the multiple-layer fabrication materials described above. In different embodiments, various types of gases or liquids can be used to inflate the balloon body 103 as desired.

The balloon 100 shown in the example of FIGS. 2 and 3 has an appearance when inflated of a bear wearing a party hat, holding a present with one arm, and with the other arm raised arm as shown communicating that “the party's here”. The bear further appears to have feet that hug the sides of the mailbox 102. The appearance of the arms and legs may be provided by two dimensional graphics printed or otherwise provided on the surface of the balloon body 103, or three dimensional arms legs, and other desired features, could be more realistic looking inflatable appendages integrated into the balloon design and construction.

In various different examples, the party decor associated with the balloon 100 in contemplated embodiments may relate to parties such as a Birthday party, an Over the Hill party, a Graduation party, a Baby party, a Superbowl party, a Luau party, a Fiesta party, a Wedding/Engagement party, a Christmas party, a Halloween party, an Easter party, a Patriotic party, a St. Patrick's Day party, a Valentine's Day party and the balloon may be accordingly configured in a size, shape, and appearance to complement any such seasonal or party-related theme.

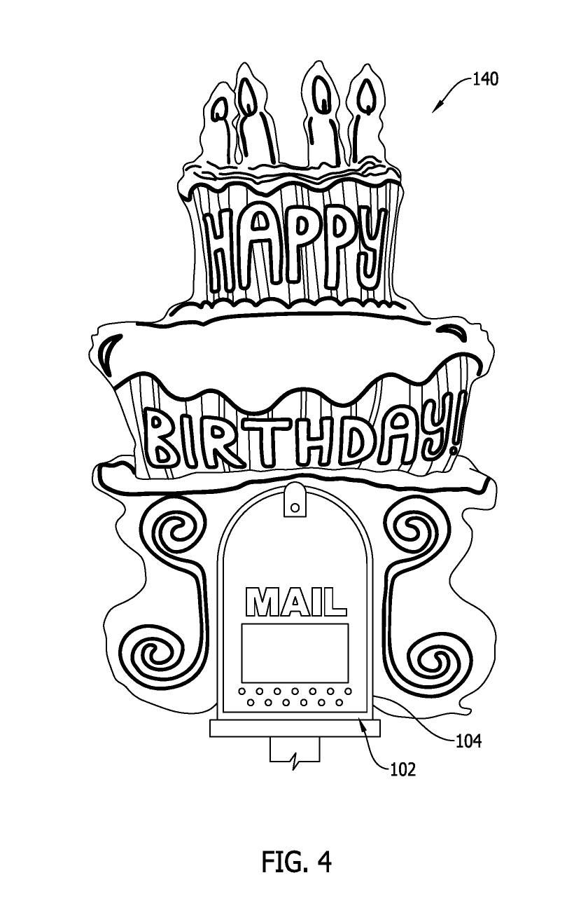

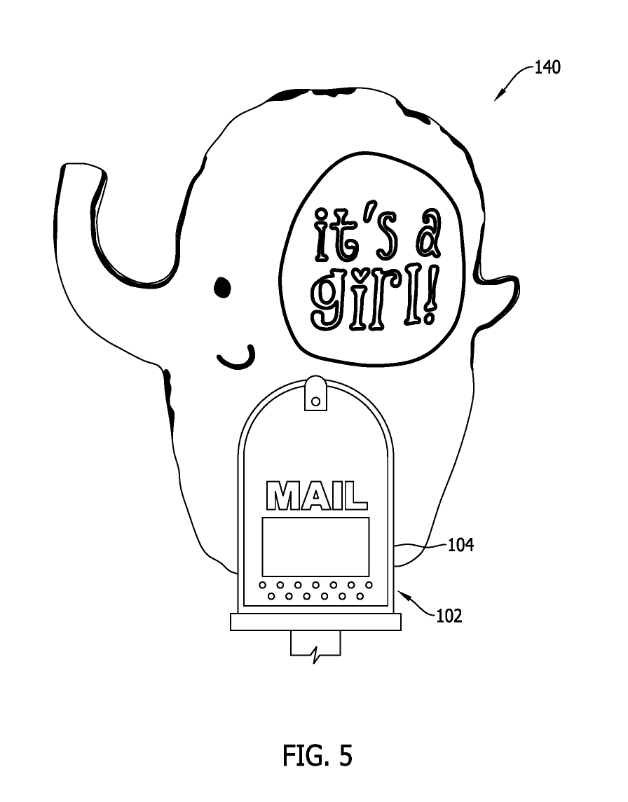

FIGS. 4 and 5 show additional variations of balloons 140 and 150 that are similarly designed and constructed to the balloon 100 shown in FIGS. 2 and 3 and therefor include inflatable bodies having pocket surfaces 104 as described above and may attached to a support element in a similar manner. The balloons 140 and 150 each have respectively distinct and alternative inflated shapes to the balloon 100.

FIG. 4 shows the balloon 140 formed in the shape of a cake on a stand that is attached to the mailbox and includes graphics that read “HAPPY BIRTHDAY”. In the example of FIG. 4, the candles on the cake are fabricated as inflatable appendages.

FIG. 5 shows the balloon 150 formed in in the shape of an elephant and attached to a mailbox with a graphic that reads “it's a girl”.

It should now be evident that various other unique balloon shapes are possible that can be conveniently and directly attached to the mailbox as shown, or to other support elements as described.

While the inventive balloons described thus far are designed for direct attachment to mailboxes, the balloon design may be readily adapted to received and attach to other support elements or anchors. The balloon design may be modified with pockets shaped and dimensioned to receiver other support surfaces of other support elements in both indoor and outdoor locations. An endless variety of possible adaptations are possible in this regard. Possible support surfaces may include light fixtures, posts, columns, gates, fences and trees in outdoor locations. Transportable support elements are also possible including furniture items such as chairs, cardboard boxes, tin containers, glass jars, baskets, and stands made of wood, plastic or metal. Transportable support elements may also include items having separate purpose such as an athletic ball, a speaker, a light, or a toy. Unique balloon and support element combinations may made be made available for purchase separately or together.

Likewise, the balloons described and illustrated that are designed for attachment to a mailbox may likewise nonetheless be attached to support elements that are not mailboxes using the features described. That is, the pocket in the balloon need not have the exact shape of the support element in order for at least some of the benefits of the invention to be realized.

The benefits and advantages of the present invention are now believed to have been amply illustrated in relation to the exemplary embodiments described.

An embodiment of a decorative balloon for a support element having an outer surface has been disclosed. The decorative balloon includes an inflatable body that is fabricated with a pocket that is shaped and dimensioned to receive and partly surround the outer surface of the support element.

Optionally, the pocket may include at least one flat surface and at least one curved surface shaped to complement the outer surface. The pocket may include an adhesive to secure the inflatable body to the outer surface of the support element. The inflatable body may include a tail that is dimensioned to tie the inflatable body to the support element. The support element may be a mailbox.

As further options, the balloon may be inflated with a fluid. The balloon may be inflated with air. The inflatable body may be fabricated from one a foil, rubber, latex, polychloroprene, or nylon. The inflatable body may be fabricated in layers. The layers may be laminated. The balloon may be shaped to complement a party theme. The party theme may relate to at least one of a Birthday party, an Over the Hill party, a Graduation party, a Baby party, a Superbowl party, a Luau party, a Fiesta party, a Wedding/Engagement party, a Christmas party, a Halloween party, an Easter party, a Patriotic party, a St. Patrick's Day party, or a Valentine's Day party. The balloon may also be shaped like an animal or like a cake.

Another embodiment of a decorative balloon for a support element having an outer surface has been disclosed. The decorative balloon includes: an inflatable body that is shaped with a concave surface that is dimensioned to receive a convex outer surface of the support element; and wherein the inflatable body is configured to directly attach to the outer surface of the support element with the inflatable body in contact with the outer surface.

Optionally, the inflatable body includes a flat surface extending from the concave surface. At least one of the flat surface and the concave surface may include an adhesive to directly attach the inflatable body to the outer surface of the support element. The inflatable body may include at least one tail dimensioned to tie the inflatable body to the support element. The inner pocket surface may include opposing side surfaces and a curved surface in between. The inflatable body may include a pocket surface, the concave surface being part of the pocket surface, and wherein the inflatable body includes one of an adhesive and a tail to secure the inflatable body to the support element. The support element may be a mailbox.

A method of attaching a decorative balloon to a support element to signify a location of an event has also been disclosed. The method includes: shaping and configuring an inflatable balloon body to signify the event, wherein the inflatable balloon body includes an inner pocket surface configured to hug an outer surface of the support element; and providing at least one of an adhesive on the inner pocket surface or a tail to secure the inflatable body in contact with the outer surface of the support element.

Optionally, providing at least one of an adhesive on the inner pocket surface or a tail comprises providing a pair of tails configured to tie the inflatable body to the support element while the pocket surface hugs the outer surface of the support element. Providing at least one of an adhesive on the inner pocket surface or a tail may also include providing an adhesive on the inner pocket surface to secure the inflatable body to the support element while the pocket surface hugs the outer surface of the support element.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A decorative balloon for a support element having an outer surface, the decorative balloon comprising:
an inflatable body that is fabricated with a pocket that is shaped and dimensioned to receive and partly surround the outer surface of the support element.

2. The decorative balloon of claim 1, wherein the pocket includes at least one flat surface and at least one curved surface shaped to complement the outer surface.

3. The decorative balloon of claim 1, wherein the pocket includes an adhesive to secure the inflatable body to the outer surface of the support element.

4. The decorative balloon of claim 1, wherein the inflatable body includes a tail that is dimensioned to tie the inflatable body to the support element.

5. The decorative balloon of claim 1, wherein the support element is a mailbox.

6. The decorative balloon of claim 1, wherein the balloon is inflated with a fluid.

7. The decorative balloon of claim 6, wherein the balloon is inflated with air.

8. The decorative balloon of claim 1, wherein the inflatable body is fabricated from one a foil, rubber, latex, polychloroprene, or nylon.

9. The decorative balloon of claim 1, wherein the inflatable body is fabricated in layers.

10. The decorative balloon of claim 9, wherein the layers are laminated.

11. The decorative balloon of claim 5, wherein the balloon is shaped to complement a party theme.

12. The decorative balloon of claim 11, wherein the party theme relates to at least one of a Birthday party, an Over the Hill party, a Graduation party, a Baby party, a Superbowl party, a Luau party, a Fiesta party, a Wedding/Engagement party, a Christmas party, a Halloween party, an Easter party, a Patriotic party, a St. Patrick's Day party, or a Valentine's Day party.

13. The decorative balloon of claim 11, wherein the balloon is shaped like an animal.

14. The decorative balloon of claim 13, wherein the balloon is shaped like a cake.

15. A decorative balloon for a support element having an outer surface, the decorative balloon comprising:
an inflatable body that is shaped with a concave surface that is dimensioned to receive a convex outer surface of the support element; and
wherein the inflatable body is configured to directly attach to the outer surface of the support element with the inflatable body in contact with the outer surface.

16. The decorative balloon of claim 15, wherein the inflatable body includes a flat surface extending from the concave surface.

17. The decorative balloon of claim 16, wherein at least one of the flat surface and the concave surface includes adhesive to directly attach the inflatable body to the outer surface of the support element.

18. The decorative balloon of claim 15, wherein the inflatable body includes at least one tail dimensioned to tie the inflatable body to the support element.

19. The decorative balloon of claim 15, wherein the inflatable body includes a pocket surface, the concave surface being part of the pocket surface, and wherein the inflatable body includes one of an adhesive and a tail to secure the inflatable body to the support element.

20. The decorative balloon of claim 19, wherein the support element is a mailbox.

21. A method of attaching a decorative balloon to a support element to signify a location of an event, the method comprising:
shaping and configuring an inflatable balloon body to signify the event, wherein the inflatable balloon body includes an inner pocket surface configured to hug an outer surface of the support element; and
providing at least one of an adhesive on the inner pocket surface or a tail to secure the inflatable body in contact with the outer surface of the support element.

22. A method according to claim 21, wherein the providing at least one of an adhesive on the inner pocket surface or a tail comprises providing a pair of tails configured to tie the inflatable body to the support element while the pocket surface hugs the outer surface of the support element.

23. A method according to claim 21, wherein the providing at least one of an adhesive on the inner pocket surface or a tail comprises providing an adhesive on the inner pocket surface to secure the inflatable body to the support element while the pocket surface hugs the outer surface of the support element.
